(19) United States
(12) Patent Application Publication
(10) Pub. No.: US 2025/0178487 A1
(43) Pub. Date: Jun. 5, 2025

(54) LONGITUDINAL ADJUSTMENT DEVICE AND VEHICLE SEAT

(71) Applicant: Adient US LLC, Plymouth, MI (US)

(72) Inventors: Ingo QUAST, Düsseldorf (DE); Erik SPRENGER, Wermelskirchen (DE); Norbert HEEG, Dahn (DE)

(21) Appl. No.: 18/961,583

(22) Filed: Nov. 27, 2024

(30) Foreign Application Priority Data
Dec. 1, 2023 (EP) 23 213 734.9

(51) Int. Cl. B60N 2/02; B60N 2/07

(52) U.S. Cl. CPC B60N 2/02258; B60N 2/0722

(57) ABSTRACT

A longitudinal adjustment device for a vehicle seat may have at least one rail arrangement with two rail pairs. The respective rail pair has a first rail element and a second rail element which are movable relative to one another. The longitudinal adjustment device may also have a motor unit, and a motor bracket with a motor mounting portion for the motor unit and at least one shaft mounting portion for at least one shaft which emanates from the motor unit. A at least one decoupling element may be provided between the motor bracket and the motor unit, between the motor bracket and the shaft, and/or between the motor bracket and a movable rail element.

### FIELD

The invention relates to a longitudinal adjustment device and to a vehicle seat with a longitudinal adjustment device of this type.

### BACKGROUND

Longitudinal adjustment devices of the type mentioned at the outset are used in vehicle seats to adjust the vehicle seat, for example by means of a rail arrangement, in particular to place it into different longitudinal seat positions in the longitudinal axial direction of the vehicle with respect to a vehicle floor. To this end, the longitudinal adjustment device usually comprises, as drive unit, a motor unit which is held on the vehicle seat by means of a bracket. The motor unit is in turn coupled in terms of movement to the rail arrangement. The bracket can be fastened, for example, to a movable rail of the rail arrangement, in particular to an upper rail, and thus enables positional securing of the drive unit and/or a shaft which emanates from the latter, in particular a drive shaft, with the result that it/they is/are connected reliably to the rail arrangement of the longitudinal adjustment device.

The invention is based on the problem of improving a longitudinal adjustment device of the type mentioned at the outset, in particular of providing a particularly low-noise longitudinal adjustment device and a corresponding vehicle seat.

According to the invention, the first-mentioned problem is solved by way of a longitudinal adjustment device with the features of claim 1. The second-mentioned problem is solved according to the invention by way of a vehicle seat with the features of claim 10.

Advantageous refinements which can be used individually or in combination with one another are the subject matter of the subclaims.

### SUMMARY

The longitudinal adjustment device according to the invention comprises at least one rail arrangement with two rail pairs, wherein the respective rail pair has a first rail element and a second rail element which are movable relative to one another. Moreover, the longitudinal adjustment device comprises a motor unit for driving the rail arrangement, and a motor bracket with a motor mounting portion for the motor unit and at least one shaft mounting portion for at least one shaft which emanates from the motor unit, in particular a drive shaft, wherein at least one decoupling element is provided in each case between the motor bracket and the motor unit, between the motor bracket and the shaft, and/or between the motor bracket and a movable rail element.

By virtue of the fact that at least one decoupling element is provided in each case between the motor bracket and the motor unit, between the motor bracket and the shaft, and/or between the motor bracket and a movable rail element, a transfer of structure-borne noise between these stated components is prevented. As a result, a considerable noise reduction of the longitudinal adjustment device is enabled. In particular, the decoupling element or elements ensures/ensure that the motor unit is decoupled as a noise source. In addition, the invention is based on the concept of reducing vibrations which emanate from movable parts such as, for example, the motor unit, the shaft and/or the movable rail element of the longitudinal adjustment device, and of reducing or preventing, in particular, a transmission or transfer of these vibrations to adjoining or adjacent components or parts of the longitudinal adjustment device. This can ensure that these vibrations do not impinge on parts with a natural frequency in the range of an excitation frequency, with the result that disruptive noise can be suppressed or is suppressed.

For example, the motor bracket and the motor unit can be decoupled from one another by means of the at least one decoupling element. In particular, the motor bracket and the motor unit can be decoupled from one another both acoustically and mechanically by means of the at least one decoupling element. As an alternative or in addition, the motor bracket and the sheathing tube can be decoupled from one another, in particular can be decoupled both acoustically and mechanically from one another, by means of the at least one decoupling element or further decoupling elements. Furthermore, the motor bracket and the movable rail element can be decoupled from one another, in particular can be decoupled both acoustically and mechanically from one another, by means of the at least one decoupling element. It is ensured by means of the respective decoupling element or the plurality of decoupling elements that a transmission or propagation of soundwaves is reduced or avoided. In other words: the motor bracket can be decoupled multiple times acoustically in the region of transitions or connectors by means of the decoupling elements which are, in particular, of separate configuration.

The motor bracket can be configured, for example, as an elongate motor bridge. The motor bracket can extend, for example, between the two rail pairs and can connect the latter. The motor bracket can be configured, in particular, as a single-part bracket. The motor bracket can be, for example, a single-part shaped component or profile component. The single-part motor bracket can comprise the motor mounting portion and the shaft mounting portion as integrated portions.

The motor mounting portion can be configured, for example, as a semi-cylindrical recess which is open on one side, in particular a rectangular recess, into which the motor unit, in particular an electric motor, is insertable.

The shaft mounting portion adjoins the motor mounting portion on one side or on both sides and extends in each case as far as the rail pair. The shaft mounting portion can be, for example, of channel-shaped configuration in order to receive the shaft. Moreover, the shaft can be arranged in a sheathing tube and can rotate in a guided manner. This sheathing tube can be insulated acoustically with respect to the motor bracket, for example, via the decoupling elements.

For example, the at least one decoupling element can be configured at least in portions as a flexible, in particular an elastic, bearing element. For example, the at least one decoupling element can be configured at least in portions as a damping, in particular vibration-damping, element.

The at least one decoupling element can have, for example, at least one guiding portion and one decoupling portion. The guiding portion can be configured, for example, as a guide profile or a guide tube.

A plurality of decoupling elements can be provided. For example, one motor decoupling element can be provided per longitudinal end for the motor unit. The respective motor decoupling element can be configured to decouple, in particular to acoustically decouple, the motor unit radially and/or axially with respect to the motor bracket, in particular the motor bridge.

A plurality of identical shaft decoupling elements can be provided for the shaft. The plurality of shaft decoupling elements can be configured, for example, such that they are connected or are connectable axially to one another with a form fit and/or a force fit. The plurality of shaft decoupling elements are identical parts and decouple the shaft radially and/or axially with respect to the motor bracket, in particular acoustically.

At least one rail decoupling element can be provided for the rail arrangement. The rail decoupling element can be configured to decouple, in particular to acoustically decouple, the movable rail with respect to the motor bracket, in particular the motor bridge.

The decoupling portion can be configured as a flexible flange. For example, the flexible flange can be configured as an edge which projects at a right angle from the guiding portion. The flexible flange can be configured both for connection and for decoupling. In particular, the flexible flange serves for connection to an adjoining component, in particular a further decoupling element and/or the motor bracket. In the case of a plurality of identical decoupling elements, they can be connected to one another axially via the flange, for example can abut one another in a flush manner, in particular can optionally be plugged into one another in regions.

At least the decoupling portion can be formed from an elastic material, in particular an elastic plastic, in particular an elastomer or rubber. The respective decoupling element is preferably formed from an elastic material which is sufficiently solid and stable to receive and guide the component to be received, in particular the motor unit, the shaft and/or the movable rail.

As described above, at least one of the decoupling elements is configured as a motor decoupling element, at least one of the decoupling elements is configured as a shaft decoupling element, and/or at least one of the decoupling elements is configured as a rail decoupling element. The shaft decoupling element can be configured, for example, as an indirect decoupling element for the shaft. In particular, the shaft decoupling element is configured as a tube decoupling element which acoustically decouples a sheathing tube or guide tube which is arranged around the shaft.

In particular, the motor decoupling element, the shaft decoupling element and the rail decoupling element can be decoupled from one another. In other words: the decoupling elements of the different components are not connected with their ends. In particular, the shaft decoupling element is not connected to the motor decoupling element or the rail decoupling element. Conversely, the motor decoupling element is not connected to the shaft decoupling element. The rail decoupling element is not connected to the shaft decoupling element either. A predetermined number of decoupling elements which are configured, in particular, as identical parts are each assigned to only one of the structural units and are arranged on the latter. In particular, a first number of decoupling elements can be assigned to the motor unit and can be arranged on the latter. A second number of decoupling elements can be assigned to the shaft and can be arranged on the latter, in particular on the sheathing tube. A third number of decoupling elements can be assigned to the movable rail and can be arranged on the latter. The various decoupling elements which are assigned, in particular, to different structural units are configured independently of one another and are arranged without contact with one another. The decoupling elements can be simply exchanged and retrofitted. The number of decoupling elements can vary. For example, a corresponding number of decoupling elements can be provided in a manner which is dependent on the length of the respective structural unit. In this way, the vehicle seat, without acoustically optimizing the substantially more complex systems such as the motor unit or gear unit, can be acoustically optimized simply by way of the integration of decoupling elements on one or more of the structural units such as the motor unit, the sheathing tube or the rail or the like. In particular, a sound level of the vehicle seat can be set by way of a combination of the decoupling elements to a predetermined value, in particular can be designed for a maximum sound level value, for example of less than 1.8 sones.

The number of decoupling elements can vary. For example, the number of decoupling elements can vary in a manner which is dependent on the shaft length and/or the motor length. A curved course of the shaft mounting portion can also require additional decoupling elements. The decoupling elements are configured, in particular, as separate components or separate elements. As a result, the decoupling elements can be retrofitted, for example, or can be replaced in the case of wear or tear. As a result, the transmission of vibrations, in particular both of acoustic vibrations and mechanical vibrations such as motor vibrations, shaft vibrations or the like, to the rail can be reduced or avoided or insulated continually over the service life of the motor and the motor bracket. As a result, both the overall stability and the comfort of the vehicle seat can be improved.

In summary and in other words, the invention provides a longitudinal adjustment device, in the case of which the noise source, the motor, is acoustically decouplable. Moreover, all vibrations which emanate from other movable parts such as the shaft and the movable rail element are also reducible by way of the integration of decoupling elements such as the shaft decoupling elements and/or the rail decoupling elements. Every above-described decoupling element can reduce the loudness in a specific vehicle seat by approximately 0.5 sone (sone=a measure of the perceived sound level, wherein a pure tone of 1 kHz and with a sound level of 40 dB corresponds to precisely one sone) in comparison with vehicle seats of a conventional design without multiple decoupling elements or without the combination described herein of different decoupling elements, in particular the combination of motor decoupling elements, shaft decoupling elements and rail decoupling elements.

### DESCRIPTION OF THE FIGURES

In the following text, the invention is explained in greater detail on the basis of advantageous exemplary embodiments which are shown in the figures. The invention is not restricted to these exemplary embodiments, however. In the figures:

FIG. 1 shows a diagrammatic illustration of a vehicle seat with a longitudinal adjustment device according to the prior art,

FIG. 2 shows a perspective view of a longitudinal adjustment device according to the invention,

FIG. 3 shows an enlarged detail in the region of a motor mounting portion of a motor bracket of the longitudinal adjustment device according to FIG. 2, and an exploded illustration of two decoupling elements,

FIG. 4 shows the illustration according to FIG. 3 with installed decoupling elements,

FIG. 5 shows an enlarged detail in the region of a shaft mounting portion of a motor bracket of the longitudinal adjustment device according to FIG. 2,

FIG. 6 shows the shaft mounting portion according to FIG. 2 in a view from the side obliquely from above,

FIG. 7 shows an enlarged detail of a fastening flange for fastening to a motor unit,

FIG. 8 shows an enlarged detail in the region of a shaft decoupling element which is configured as a sheathing tube decoupling means,

FIG. 9 shows a perspective sectional illustration of a rail pair in the region of a rail decoupling element, and

FIG. 10 shows an enlarged perspective sectional illustration of the rail decoupling element according to FIG. 9.

### DETAILED DESCRIPTION

Parts which correspond to one another are provided with the same reference signs in all the figures.

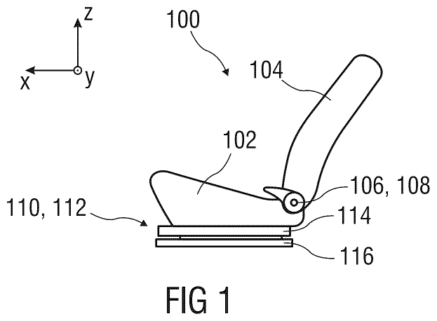

A vehicle seat 100 which is shown diagrammatically in FIG. 1 with regard to the prior art will be described in the following text with the use of three spatial directions which run perpendicularly with respect to one another. In the case of a vehicle seat 100 which is installed in the vehicle, a longitudinal direction x runs largely horizontally and preferably parallel to a vehicle longitudinal direction which corresponds to the usual direction of travel of the vehicle. A transverse direction y which runs perpendicularly with respect to the longitudinal direction x is likewise oriented horizontally in the vehicle and runs parallel to a vehicle transverse direction. A vertical direction z runs perpendicularly with respect to the longitudinal direction x and perpendicularly with respect to the transverse direction y. In the case of a vehicle seat 100 which is installed in the vehicle, the vertical direction z preferably runs parallel to a vehicle vertical axis.

The positional and directional specifications used such as, for example, front, rear, top and bottom relate to a viewing direction of an occupant seated in the vehicle seat 100 in a normal seating position, wherein the vehicle seat 100 is installed in the vehicle, in a use position suitable for passenger transport with an upright backrest 104 and oriented as is customary in the direction of travel. The vehicle seat 100 can, however, also be installed or moved in a different orientation, for example transversely with respect to the direction of travel. Unless described differently, the vehicle seat 100 is of mirror-symmetrical construction with respect to a plane which runs perpendicularly with respect to the transverse direction y.

The backrest 104 can be arranged pivotably on a seat part 102 of the vehicle seat 100. To this end, the vehicle seat 100 can optionally comprise a fitting 106, in particular an adjusting fitting, swivel fitting, latching fitting or tumbling fitting.

The positional and directional specifications used such as, for example, radial, axial and in the peripheral direction relate to a rotational axis 108 of the fitting 106. Radial means perpendicular with respect to the rotational axis 108. Axial means in the direction of or parallel to the rotational axis 108.

The vehicle seat 100 can optionally comprise a longitudinal adjustment device 110. The longitudinal adjustment device 110 comprises, for example, a rail arrangement 112 with a first rail element 114 and a second rail element 116. The first rail element 114 is adjustable in the longitudinal direction x relative to the second rail element 116. The first rail element 114 is fastened to the seat part 102. The second rail element 116 is fastened to a structural element of a vehicle, for example a vehicle floor.

For improved clarity, the first rail element 114 is called the upper rail 114 in the following description. This upper rail 114 (also called running rail or slide) is assigned to the vehicle seat 100 and is configured to support this vehicle seat 100. The second rail element 116 is called a lower rail 116 in the further text. The lower rail 116 is connected fixedly and, for example, to the floor of a vehicle.

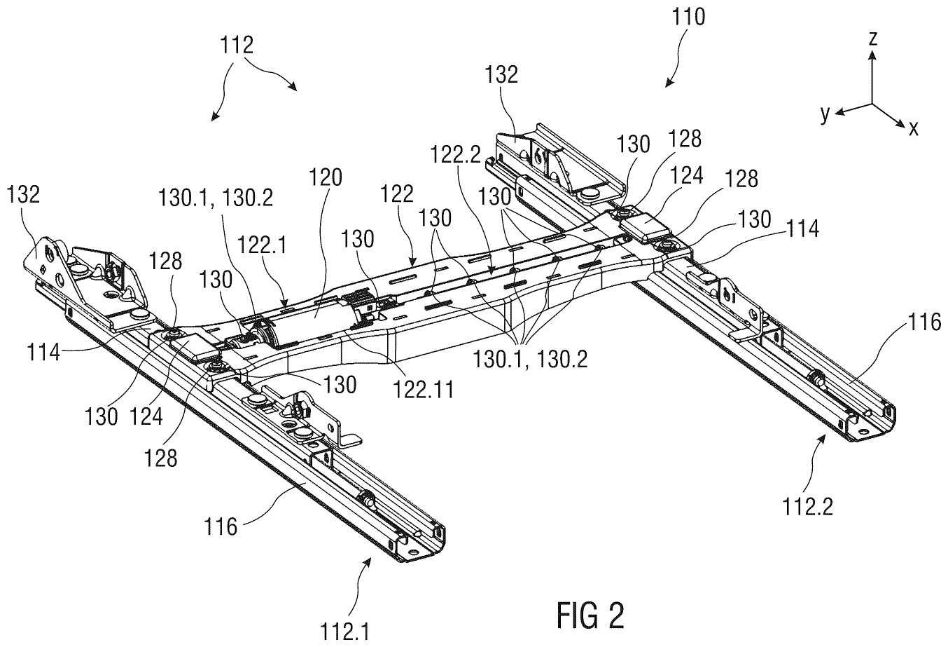

FIG. 2 shows a perspective view of the longitudinal adjustment device 110 according to the invention.

The longitudinal adjustment device 110 according to the invention comprises at least the rail arrangement 112 with two rail pairs 112.1, 112.2. The respective rail pair 112.1, 112.2 comprises the upper rail 114 as first rail element 114 and the lower rail 116 as second rail element 116. The respective upper rail 114 is movable longitudinally with respect to the lower rail 116.

Moreover, for adjustment of the upper rail 114 by electric motor, the longitudinal adjustment device 110 comprises a motor unit 120, in particular an electric motor, and a motor bracket 122 for the motor unit 120.

In order to couple the motor unit 120 to the rail arrangement 112, a gear unit 124 which couples the motor unit 120 and the movable upper rail 114 of at least one of the rail pairs 112.1, 112.2 to one another is provided per rail pair 112.1, 112.2.

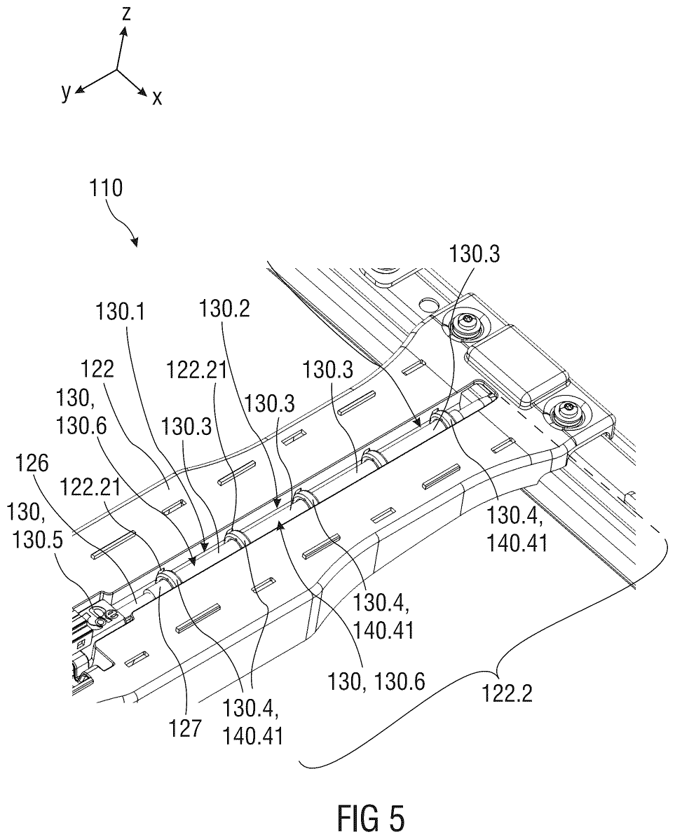

The motor bracket 122 has at least one motor mounting portion 122.1 for the motor unit 120 and at least one shaft mounting portion 122.2 for at least one shaft 126 which emanates from the motor unit 120, in particular a drive shaft (shown in FIG. 5). The shaft 126 is, in particular, a flexible shaft which is guided in a sheathing tube 127 (also called a guide tube).

The motor bracket 122 is fastened to the upper rail 114 at fastening points 128 by means of fastening elements 128.1, for example screws.

At least one decoupling element 130 is arranged in each case between the motor bracket 122 and the motor unit 120, between the motor bracket 122 and the shaft 126, in particular the sheathing tube 127, and/or between the motor bracket 122 and the movable upper rail 114. In other words: the longitudinal adjustment device 110 comprises a combination of a plurality of decoupling elements 130.

The respective decoupling element 130 can be configured at least in portions as a resilient, in particular an elastic, bearing element 130.1. For example, the at least one decoupling element 130 can be configured at least in portions as a damping, in particular vibration-damping, element 130.2.

A transfer of structure-borne sound between the stated components, in particular between the motor bracket 122 and the motor unit 120, between the motor bracket 122 and the shaft 126, and/or between the motor bracket 122 and the movable upper rail 114, is prevented by means of the decoupling elements 130, in particular the flexible bearing elements 130.1 and/or the damping elements 130.2.

The motor bracket 122 is configured, for example, as an elongate motor bridge or a motor support profile. The motor bracket 122 extends, for example, between the two rail pairs 112.1, 112.2 and connects them. Via seat mounts 132, the longitudinal adjustment device 110 is fastened to the vehicle seat 100 (shown in FIG. 1).

The motor mounting portion 122.1 can be configured, for example, as a semicylindrical recess 122.11 which is open on one side. For example, the recess 122.11 is configured in accordance with the contour and external shape of the motor unit 120. The recess 122.11 can be of rectangular configuration. The motor unit 120, in particular an electric motor, is insertable into the recess 122.11. The recess 122.11 is configured in such a way that the motor unit 120 is held releasably in this recess 122.11 with a form fit and/or force fit.

The shaft mounting portion 122.2 adjoins the motor mounting portion 122.1 on one side or on both sides, and extends in each case as far as the rail pair 112.1, 112.2. The shaft mounting portion 122.2 can be, for example, of channel-shaped configuration in order to receive the shaft 126 (shown in FIG. 5) which is guided in the sheathing tube 127.

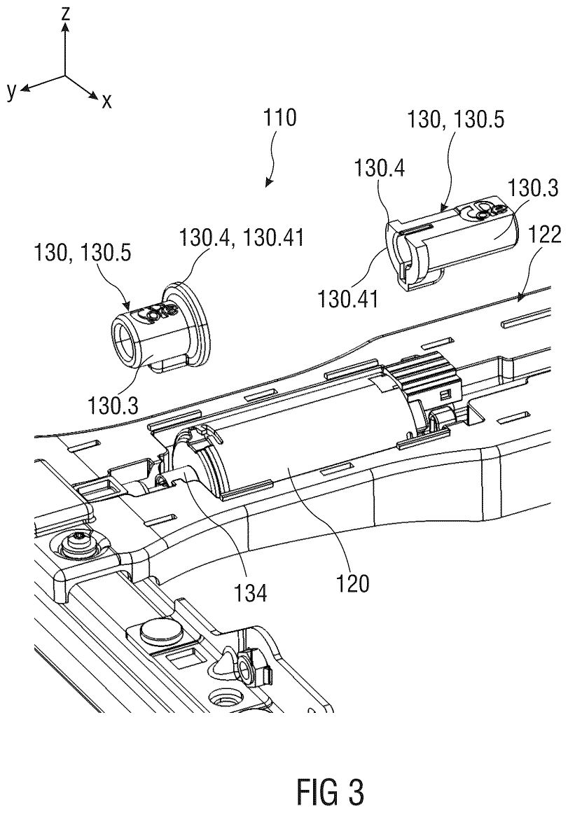

FIG. 3 shows an enlarged detail in the region of the motor mounting portion 122.1 of the motor bracket 122 of the longitudinal adjustment device 110 according to FIG. 2 and an exploded illustration of two decoupling elements 130.

The respective decoupling element 130 can have, for example, at least one guiding portion 130.3 and one decoupling portion 130.4.

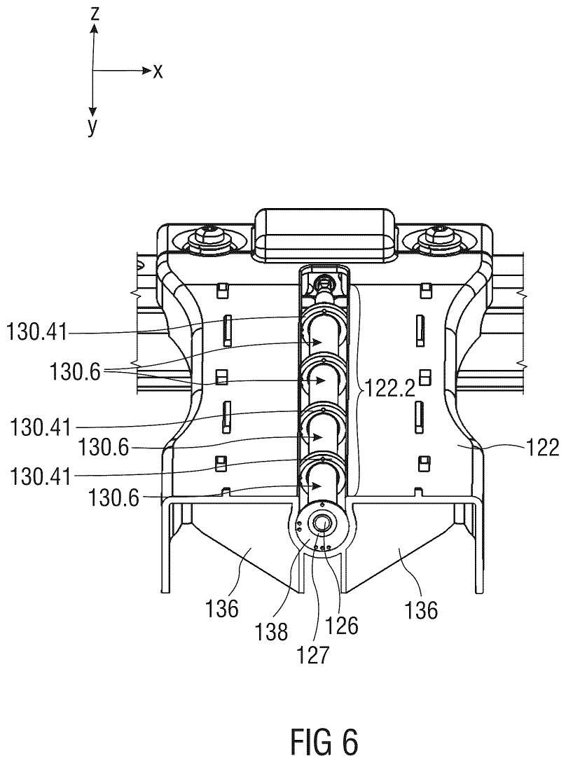

The guiding portion 130.3 can be configured, for example, as a guide profile or a guide tube, sheathing tube or the like. The guiding portion 130.3 is configured to receive, for example, a motor end 134 or the shaft 126 which emanates from the motor unit 120 (shown in FIG. 6). To this end, the guide portion 130.3 can be configured as a through opening.

The decoupling elements 130 are provided at each longitudinal end of the motor unit 120 and are configured as motor decoupling elements 130.5. The respective motor decoupling element 130.5 can be configured, for example, to decouple, in particular to acoustically decouple, the motor unit 120 radially and/or axially, in particular in the transverse direction y, with respect to the motor bracket 122, in particular the motor bridge.

At least the decoupling portion 130.4 which is configured as a flange 130.41 can be formed from an elastic material, in particular in elastic plastic, for example an elastomer or rubber. The respective decoupling element 130, as is also described in the following text, is preferably formed completely from an elastic material which is configured to be sufficiently strong and stable to receive and guide the component to be received, in particular the motor unit 120, the shaft 126 and/or the movable upper rail 114.

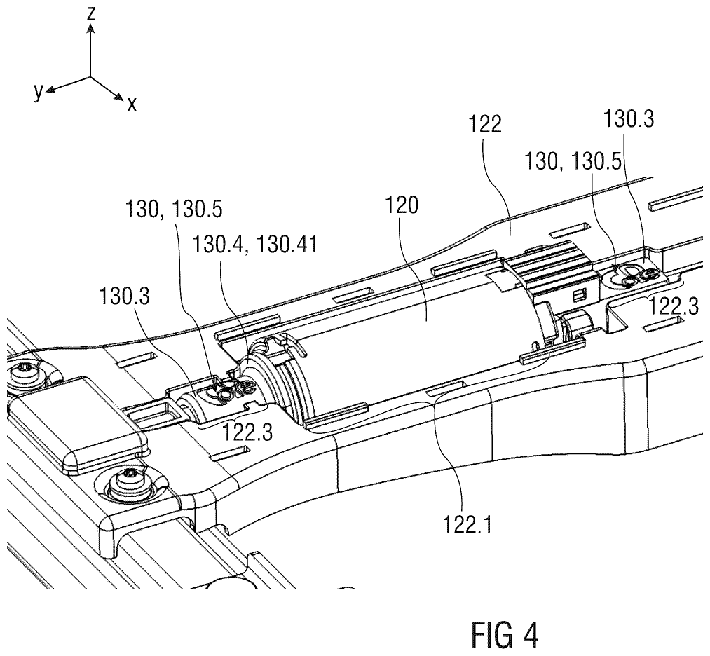

FIG. 4 shows the illustration according to FIG. 3 with installed decoupling elements 130 which are configured as motor decoupling elements 130.5. The motor unit 120 is arranged with a form fit and/or force fit in the motor mounting portion 122.1 and is held releasably.

In each case one of the motor decoupling elements 130.5 is arranged in transition portions 122.3. The decoupling portion 130.4 of the respective motor decoupling element 130.5 is configured, for example, as a flange 130.41. The decoupling portion 130.4 is configured, in particular, as a flexible flange 130.41.

The flange 130.41 can be configured, for example, as an edge which projects at a right angle from the guiding portion 130.3. The guiding portion 130.3 can have an outer shape which is adapted to the motor bracket 122, in particular an outer shape which is round or polygonal or round in portions or straight in portions.

The flexible flange 130.41 can be configured both for connection to the motor unit 120 and for acoustic decoupling of the motor unit 120 from the motor bracket 122.

FIG. 5 shows an enlarged detail in the region of the shaft mounting portion 122.2 of the motor bracket 122 of the longitudinal adjustment device 110 according to FIG. 2.

The shaft 126 is configured as a flexible shaft, and is coupled via the motor decoupling element 130.5 to an output element (not shown in greater detail) of the motor unit 120.

A plurality of decoupling elements 130 which are configured as shaft decoupling elements 130.6 can be provided for the shaft 126. The plurality of shaft decoupling elements 130.6 can be configured, for example, such that they are connected axially to one another with a form fit and/or force fit and releasably. The plurality of shaft decoupling elements 130.6 are identical parts or are of identical configuration. The shaft decoupling elements 130.6, in particular their decoupling portions 130.4 which are configured as a flexible flange 130.41, decouple the shaft 126 radially and/or axially with respect to the motor bracket 122, in particular acoustically.

The plurality of identical shaft decoupling elements 130.6 can be connected to one another axially via the flexible flanges 130.41. For example, the respective flange 130.41 of the one decoupling element 130 abuts in a flush manner a front-side end of the guiding portion 130.3 of an adjacent decoupling element 130, and/or they are plugged into one another in regions.

The shaft mounting portion 122.2 has flange mountings 122.21 which correspond with the flanges 130.41. The flanges 130.41 are arranged with a form fit and/or force fit in the flange mountings 122.21 and are held releasably.

The guiding portion or portions 130.3 of the shaft decoupling elements 130.6 can form the sheathing tube 127 for the shaft 126, for example as a single-part or multiple-part guide tube. Here, the decoupling portions 130.4 can be arranged as separate, in particular annular, damping elements at uniform spacings on the sheathing tube 127. The sheathing tube 127 and/or the end-side guiding portions 130.3 are decoupled with regard to the motor bridge or motor bracket 122 by means of the decoupling portions 130.4 which are configured as flanges 130.41.

FIG. 6 shows the shaft mounting portion 122.2 according to FIG. 2 in a view from the side obliquely from above. The shaft decoupling elements 130.6 are configured in each case, for example, as a sheathing tube 127 (also called a guide tube or guide sleeve) for receiving, guiding and mounting the shaft 126. The shaft 126 can be, in particular, what is known as a flex-shaft.

The motor bracket 122 is configured as a profile body, in particular a motor bridge. The motor bracket 122 is configured, for example, as a U-shaped profile with reinforcing elements 136, for example ribs.

The shaft mounting portion 122.2 is configured as a half-open channel, in which the shaft decoupling elements 130.6 are arranged, in which in turn the shaft 126 is guided and mounted rotatably. By means of the flanges 130.41, the shaft 126 is decoupled acoustically with respect to the motor bracket 122.

In the direction of the motor unit 120, a fastening flange 138 for fastening to the motor unit 120 is provided at the end of the shaft decoupling element 130.6 which faces the motor unit 120.

FIG. 7 shows an enlarged detail of the fastening flange 138. The fastening flange 138 has an outer shape which corresponds with the shape of the channel-shaped shaft mounting portion 122.2.

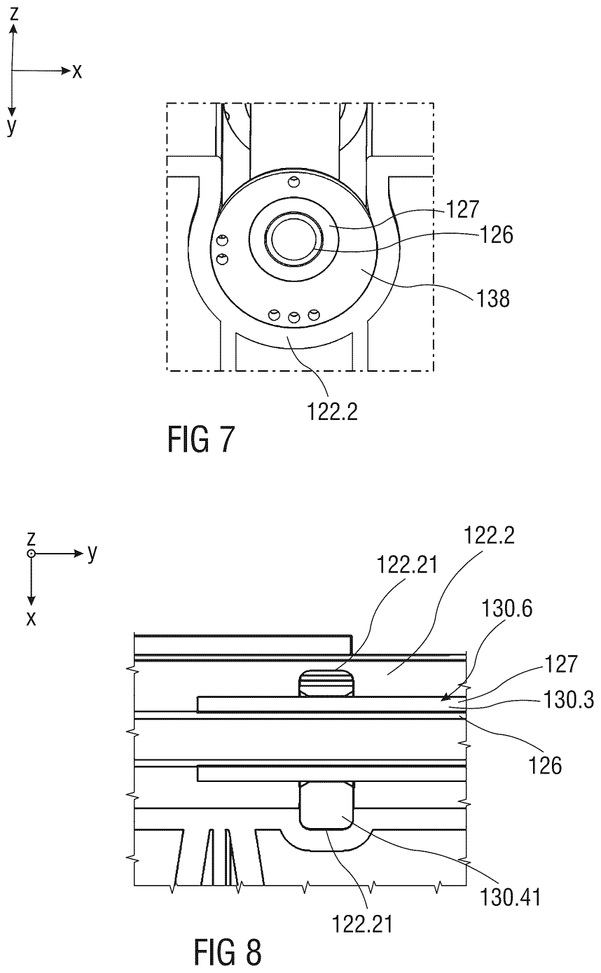

FIG. 8 shows an enlarged detail in the region of the shaft decoupling element 130.6. The flange 130.41 is held releasably with a form fit and/or force fit in the flange mounting 122.21 of the shaft mounting portion 122.2.

The guiding portion 130.3 is of channel-shaped configuration. The guiding portion 130.3 has, in particular, internal dimensions which correspond with external dimensions of the shaft 126.

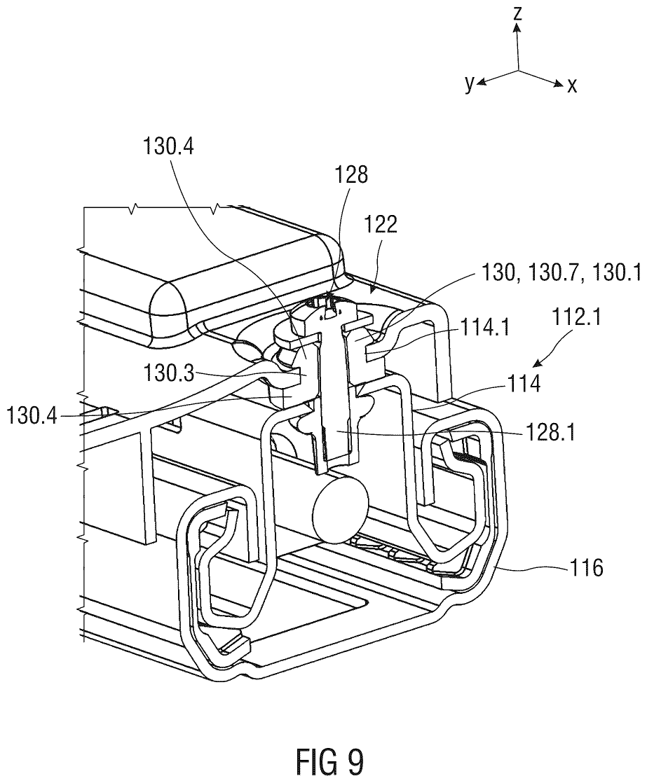

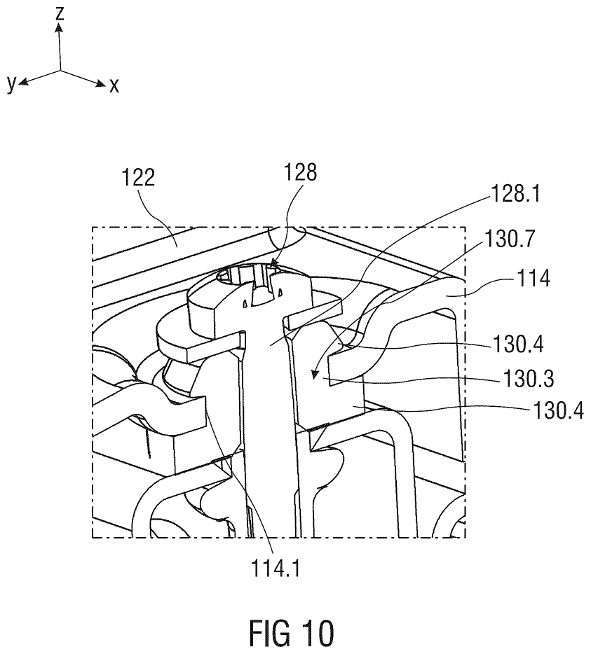

FIG. 9 shows a perspective sectional illustration of one of the rail pairs 112.1 in the region of a decoupling element 130 which is configured as a rail decoupling element 130.7 and acoustically decouples the movable upper rail 114 from the motor bracket 122 at the fastening point 128. FIG. 10 shows an enlarged perspective sectional illustration of the rail decoupling element 130.7 according to FIG. 9.

At the fastening point 128, the motor bracket 122 is connected to the movable upper rail 114 by means of a fastening element 128.1, in particular a screw. For acoustic decoupling of the upper rail 114 and the motor bracket 122, the rail decoupling element 130.7 is configured as a flexible or elastic bearing element 130.1, for example made from an elastic plastic material or from rubber or the like.

The rail decoupling element 130.7 is arranged in a fastening opening 114.1 of the upper rail 114 for the fastening element 128.1, and has the guiding portion 130.3 and decoupling portions 130.4.

Each of the decoupling elements 130 presented here, for example the motor decoupling elements 130.5, the shaft decoupling elements 130.6, the rail decoupling elements 130.7, reduce the loudness in the respective vehicle seat 100 by approximately 0.5 sone in comparison with seat longitudinal adjusters of a conventional design.

Here, the different decoupling elements 130, in particular the motor decoupling elements 130.5, are decoupled from the shaft decoupling elements 130.6, and these shaft decoupling elements 130.6 are decoupled from the rail decoupling elements 130.7. In other words: the shaft decoupling elements 130.6, configured for example as sheathing tubes, of the flexible shaft 126 (also called a flex-shaft) are connected by way of their ends neither to the motor unit 120 nor to the motor decoupling elements 130.5 nor to the gear unit 124 and the rail decoupling elements 130.7. The shaft decoupling elements 130.6 are therefore likewise completely decoupled via the flexible flanges 130.41 from the motor bracket 122 and the other adjoining components/assemblies.

The structure-borne sound excitation of the motor unit 120 is reduced via mounting of the motor of the motor unit 120 in the decoupling elements 130, configured as flexible bearing elements 130.1, for example rubber elements. The selection of the Shore hardness and the thickness of the material of the decoupling elements 130, for example an elastomer, are adapted to the reduction of frequencies which act, in particular structure-borne sound which acts on account of movable parts. Both the decoupling elements 130, in particular both those for the motor unit 120 and also the other decoupling elements 130 for the shaft 126 and the upper rail 114, combine spring properties and damping properties which are adapted or can be adapted in an optimum manner to the vibration frequencies which occur.

The number of decoupling elements 130 can vary in a manner which is dependent on the size, in particular the dimensions, of the longitudinal adjustment device 110, in particular the shaft 126 and its length (also called flex-shaft length or sheathing tube length). A curved course of the shaft 126 or of a sheathing tube which surrounds it can also require additional supports via these flexible flanges 130.41.

By way of the combination of the above-described different decoupling elements 130 which are configured as motor decoupling elements 130.5, shaft decoupling elements 130.6 and/or rail decoupling elements 130.7, it is possible for the loudness of the longitudinal adjustment device 110 to be reduced to less than 1.8 sones on the vehicle seat 100, in particular a padded seat with measurement of the acoustics at the head.

### LIST OF REFERENCE SIGNS

100 Vehicle seat
102 Seat part
104 Backrest
106 Fitting
108 Rotational axis
110 Longitudinal adjustment device
112 Rail arrangement
112.1, 112.2 Rail pair
114 First rail element (upper rail)
114.1 Fastening opening
116 Second rail element (lower rail)
120 Motor unit
122 Motor bracket
122.1 Motor mounting portion
122.11 Recess
122.2 Shaft mounting portion
122.21 Flange mounting
122.3 Transition portion
124 Gear unit
126 Shaft
127 Sheathing tube
128 Fastening point
128.1 Fastening element
130 Decoupling element
130.1 Elastic bearing element
130.2 Damping element
130.3 Guiding portion
130.4 Decoupling portion
130.41 Flange
130.5 Motor decoupling element
130.6 Shaft decoupling element
130.7 Rail decoupling element
132 Seat mount
134 Motor end
136 Reinforcing element
138 Fastening flange
x Longitudinal direction
y Transverse direction
z Vertical direction

What is claimed is:

1. A longitudinal adjustment device for a vehicle seat, comprising:
a rail arrangement with two rail pairs, wherein the respective rail pair has a first rail element and a second rail element which are movable relative to one another,
a motor unit, and
a motor bracket with a motor mounting portion for the motor unit and at least one shaft mounting portion for at least one shaft which emanates from the motor unit and has a sheathing tube,
wherein at least one decoupling element is provided in each case between the motor bracket and the motor unit, between the motor bracket and the sheathing tube, and/or between the motor bracket and a movable rail element.

2. The longitudinal adjustment device according to claim 1, wherein the motor bracket and the motor unit are decoupled from one another by means of the at least one decoupling element.

3. The longitudinal adjustment device according to claim 1, wherein the motor bracket and the sheathing tube are decoupled from one another by means of the at least one decoupling element.

4. The longitudinal adjustment device according to claim 1, wherein the motor bracket and the movable rail element are decoupled from one another by means of the at least one decoupling element.

5. The longitudinal adjustment device according to claim 1, wherein the at least one decoupling element is configured at least in portions as a flexible bearing element.

6. The longitudinal adjustment device according to claim 1, wherein the at least one decoupling element has at least one guiding portion and one decoupling portion.

7. The longitudinal adjustment device according to claim 6, wherein the guiding portion is configured as a guide tube.

8. The longitudinal adjustment device according to claim 6, wherein the decoupling portion is configured as a flexible flange.

9. The longitudinal adjustment device according to claim 8, wherein the flexible flange is configured as an edge which projects at a right angle from the guiding portion, and is configured both for connection and for acoustic decoupling.

10. The longitudinal adjustment device according to claim 6, wherein at least the decoupling portion is formed from an elastic material.

11. The longitudinal adjustment device according to claim 1, wherein at least one of the decoupling elements is configured as a motor decoupling element, at least one of the decoupling elements is configured as a shaft decoupling element, and/or at least one of the decoupling elements is configured as a rail decoupling element.

12. The longitudinal adjustment device according to claim 11, wherein the motor decoupling element/elements, the shaft decoupling element/elements and the rail decoupling element/elements are decoupled from one another.

13. The longitudinal adjustment device according to claim 1, wherein the respective decoupling element is configured as a separate component.

14. The longitudinal adjustment device according to claim 1, wherein the motor bracket is configured as a single-part bracket.

15. A vehicle seat with the longitudinal adjustment device according to claim 1.
